(19) United States
(12) Patent Application Publication
(10) Pub. No.: US 2007/0253112 A1
(43) Pub. Date: Nov. 1, 2007

(54) Read/write system for a hard drive

(76) Inventor: Kenneth D. Hall, Sterling, VA (US)

Correspondence Address: DONALD R. SCHOONOVER, 4211 ROLLING HILLS DRIVE, NIXA, MO, 65714-8771, US

(21) Appl. No.: 11/412,199

(22) Filed: Apr. 27, 2006

(51) Int. Cl. G11B 5/55

(52) U.S. Cl. 360/244

(57) ABSTRACT

A read head unit and a write head unit are fixed in place with respect to a rotating disc which rotates beneath the fixed head units. Each head unit includes a plurality of elements to read data from, or write data onto, the disc as appropriate.

### BACKGROUND OF THE INVENTION

1. Field of the Invention

The present invention relates to the general art of computer hardware, and to the particular field of hard drives of computers.

2. Description of the Related Art

Computers commonly use disc drives for memory storage purposes. Disc drives include a stack of one or more magnetic discs that rotate and are accessed using a head or read-write transducer. Typically, a high speed motor such as a spindle motor is used to rotate the discs.

An example of a conventional spindle motor includes a base which is usually made from die cast aluminum, a stator, a shaft, bearings and a disc support member, also referred to as a hub. A magnet and flux return ring are attached to the disc support member. The stator is separated from the base using an insulator and attached to the base using an adhesive. Distinct structures are formed in the base and the disc support member to accommodate the bearings. One end of the shaft is inserted into the bearing positioned in the base and the other end of the shaft is placed in the bearing located in the hub. A separate electrical connector may also be inserted into the base.

Each of these parts must be fixed at predefined tolerances with respect to one another. Accuracy in these tolerances can significantly enhance motor performance.

In operation, the disc stack is placed upon the hub. The stator windings are selectively energized and interact with the permanent magnet to cause a defined rotation of the hub. As the hub rotates, the head engages in reading or writing activities based upon instructions from the CPU of the computer.

Manufacturers of disc drives are constantly seeking to improve the speed with which data can be accessed. To an extent, this speed depends upon the speed of the spindle motor, as existing magneto-resistive head technology is capable of accessing data at a rate greater than the speed offered by the highest speed spindle motor currently in production. The speed of the spindle motor is dependent upon the dimensional consistency or tolerances between the various components of the motor. Greater dimensional consistency between components leads to a smaller gap between the stator and the magnet, producing more force, which provides more torque and enables faster acceleration and higher rotational speeds. One drawback of conventional spindle motors is that a number of separate parts are required to fix motor components to one another. This can lead to stack up tolerances which reduce the overall dimensional consistency between the components. Stack up tolerances refers to the sum of the variation of all the tolerances of all the parts, as well as the overall tolerance that relates to the alignment of the parts relative to one another.

In an effort to enable increased motor speed, some hard disc manufacturers have turned to the use of hydrodynamic bearings. These hydrodynamic bearings, however, have different aspect ratios from conventional bearings. An example of a different aspect ratio may be found in a cylindrical hydrodynamic bearing in which the length of the bearing is greater than it's diameter. This results in more susceptibility to problems induced by differing coefficients of thermal expansion than other metals used in existing spindle motors, making it difficult to maintain dimensional consistency over the operating temperature that the drive sees between the hydrodynamic bearings and other metal parts of the motor. Hydrodynamic bearings have less stiffness than conventional ball bearings so they are more susceptible to imprecise rotation when exposed to vibrations or shock.

An important characteristic of a hard drive is the amount of information that can be stored on a disc. One method to store more information on a disc is to place data tracks more closely together. Presently this spacing between portions of information is limited due to vibrations occurring during the operation of the motor. These vibrations can be caused when the stator windings are energized, which results in vibrations of a particular frequency. These vibrations also occur from harmonic oscillations in the hub and discs during rotation, caused primarily by non-uniform size media discs.

An important factor in motor design is the lowering of the operating temperature of the motor. Increased motor temperature affects the electrical efficiency of the motor and bearing life. As temperature increases, resistive loses in wire increase, thereby reducing total motor power. Furthermore, it can be predicted that the failure rate of an electrical device is exponentially related to its operating temperature. The frictional heat generated by bearings increases with speed. Also, as bearings get hot they expand, and the bearing cages get stressed and may deflect, causing non-uniform rotation and the resultant of further heat increase, non-uniform rotation requiring greater spacing in data tracks, and reduced bearing life. One drawback with existing motor designs is their limited effective dissipation of the heat, and difficulty in incorporating heat sinks to aid in heat dissipation. In addition, the operating temperatures of current motors generally increase as the size of the motor is decreased.

Manufacturers have established strict requirements on the outgassing of materials that are used inside a hard disc drive. These requirements are intended to reduce the emission of materials onto the magnetic media or heads during the operation of the drive. Of primary concern are adhesives that are used to attach components together, varnish that is used to insulate wire, and epoxy that is used to protect steel laminations from oxidation.

In addition to such outgassed materials, airborne particulate matter in a drive may lead to head damage. Also, airborne particulates in the disc drive could interfere with signal transfer between the read/write head and the media. To reduce the effects of potential airborne particulate matter, hard drives are manufactured to exacting clean room standards and air filters are installed inside of the drive to reduce the contamination levels during operation.

Heads used in disc drives are susceptible to damage from electrical shorts passing through a small air gap between the media and the head surface. In order to prevent such shorts, some hard drives use a plastic or rubber ring to isolate the spindle motor from the hard drive case. A drawback to this design is the requirement of an extra component.

Therefore, there is a need to improve the speed of a hard drive without the drawbacks discussed above.

Furthermore, due to the consuming public's awareness of various performance specifications, many hard drive vendors have opted for faster external interface timing specifications. However for various architectural reasons, having faster external interface timing does not necessarily result in overall faster throughput. A faster external interface could result in decreased throughput if the hard drive is unable to sustain the reading of data from sequential sectors without experiencing missed revolutions.

Many hard drives employ a single ported internal data buffer which must be multiplexed between the external interface and the internal read/write heads. By having a very aggressive external interface timing the proper balance of access between the external interface, the internal read/write heads, and the internal data buffer might not be achieved, causing the internal read/write heads being denied access to the single ported internal data buffer at the beginning of a sector, resulting in missed disk revolutions. In other words, no data will be transferred between the media and the single ported internal data buffer during these revolutions.

The frequency of having missed disk revolutions is dependent upon the Transfer Block Size, the Access Block Size, and the ability of the drive to intelligently manage its buffer. The Access Block Size is an attribute of the Operating System and Device Driver or BIOS being used to access the hard drive. Transfer Block Size may be negotiated between the software running on the host processor (either the Device Driver or BIOS) and the hard drive.

Today, most BIOS either do not account for differences in hard drives and arbitrarily assign a Transfer Block Size, or allow a user to interrupt the boot-up process, and specify a Transfer Block Size. The user specified Transfer Block Size is stored in CMOS1 memory where it is retained for subsequent boot-ups until it is overridden with a new value. However, for personal computer systems, only the very sophisticated users understand how the hard drives' overall performance can be fine-tuned by altering the Transfer Block Size. Even for these sophisticated users, very little help is available for them to ascertain what the appropriate Transfer Block Size should be.

Therefore, there is a need for a means for improving hard drive performance in a manner that does not require operations by a sophisticated consumer.

### PRINCIPAL OBJECTS OF THE INVENTION

It is a main object of the present invention to provide a means to improve the speed of a hard drive without the drawbacks discussed above.

It is another object of the present invention to provide a means for improving hard drive performance in a manner that does not require operations by a sophisticated consumer.

### SUMMARY OF THE INVENTION

These, and other, objects are achieved by a system that includes a read head unit that is fixed with respect to the hard disc and a write head unit that is fixed with respect to the hard disc whereby the hard disc rotates with respect to the fixed read head and write head units. Each unit includes a plurality of elements for reading data from, or writing data onto, the hard disc as it rotates past the unit.

Using the system embodying the present invention will permit rapid data movement to and/or from the hard disc without the problems encountered with the prior art. Multiple tracks can be read or written simultaneously.

### BRIEF DESCRIPTION OF THE DRAWING FIGURES

FIG. 1 is a perspective view of a hard drive unit embodying the present invention.

FIG. 2 is a cutaway elevational view of the hard drive unit shown in FIG. 1.

FIG. 3 is a top plan view of a disc located beneath fixed read heads and fixed write heads, each of which has elements located with respect to the disc to read tracks on the disc as the disc spins beneath the fixed heads in accordance with the present invention.

FIG. 4 is a top plan view similar to FIG. 3, with multiple fixed read heads and multiple fixed write heads in accordance with the present invention.

FIG. 5 is a schematic showing elements in a fixed head to be associated with tracks in a disc located subadjacent to the fixed head in accordance with the present invention.

FIG. 6 is an elevational sketch showing multiple discs, each of which is associated with fixed read heads and fixed write heads in accordance with the present invention.

### DETAILED DESCRIPTION OF THE PREFERRED EMBODIMENT

Other objects, features and advantages of the invention will become apparent from a consideration of the following detailed description and the accompanying drawings.

Referring to the Figures, it can be understood that the present invention is embodied in a read/write system 10 for a hard drive 12 which achieves the above-stated objectives.

System 10 comprises a hard drive disc 14 which is rotated during use as will be understood by those skilled in the art.

System 10 further comprises a read head unit 20 which is fixed in place with respect to hard drive disc 14 whereby the hard drive disc 14 rotates with respect to the read head unit 20. The read head unit 20 can be fixedly mounted on a housing 22 or the like.

As can be understood from FIG. 5, read head unit 20 includes a plurality of data reading elements 24 located to read data from the hard drive disc 14 when necessary.

System 10 further includes a write head unit 30 which is fixed in place with respect to the hard drive disc 14 as by being fixedly mounted to housing 22 whereby the hard drive disc 14 rotates with respect to write head unit 30. Similarly to read head unit 20 shown in FIG. 5, write head unit 30 includes a plurality of data writing elements 32 located to write data onto the hard drive disc 14 when 30 necessary.

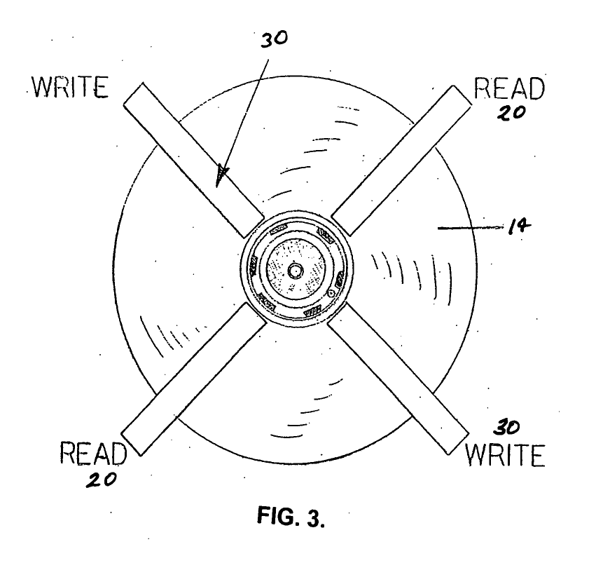

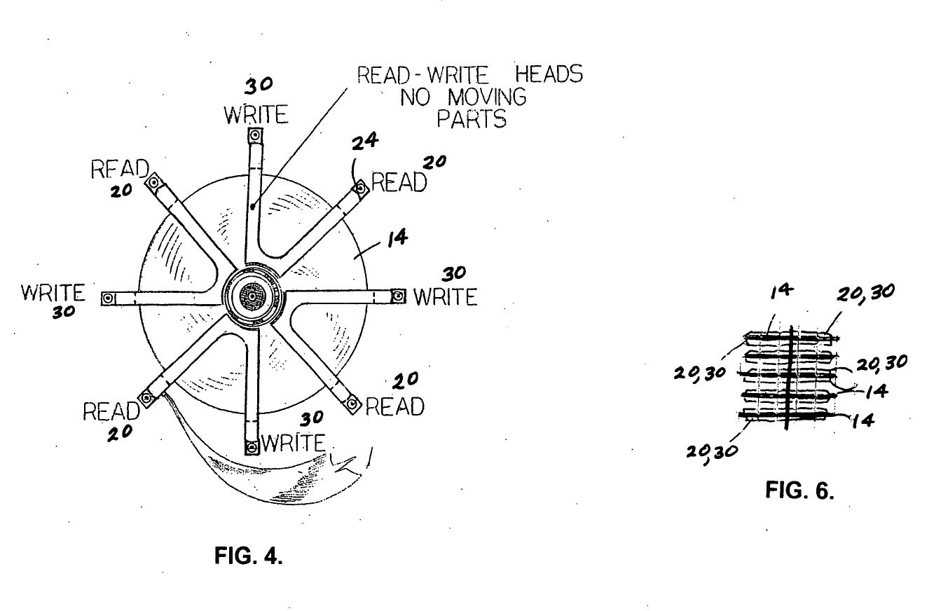

As can be understood from FIGS. 3 and 4, system 10 can include a plurality of read head units 20 and a plurality of write head units 30, with the units being oriented radially with respect to disc 14. Each of the plurality of read and write head units includes a plurality of read or write elements respectively as taught above.

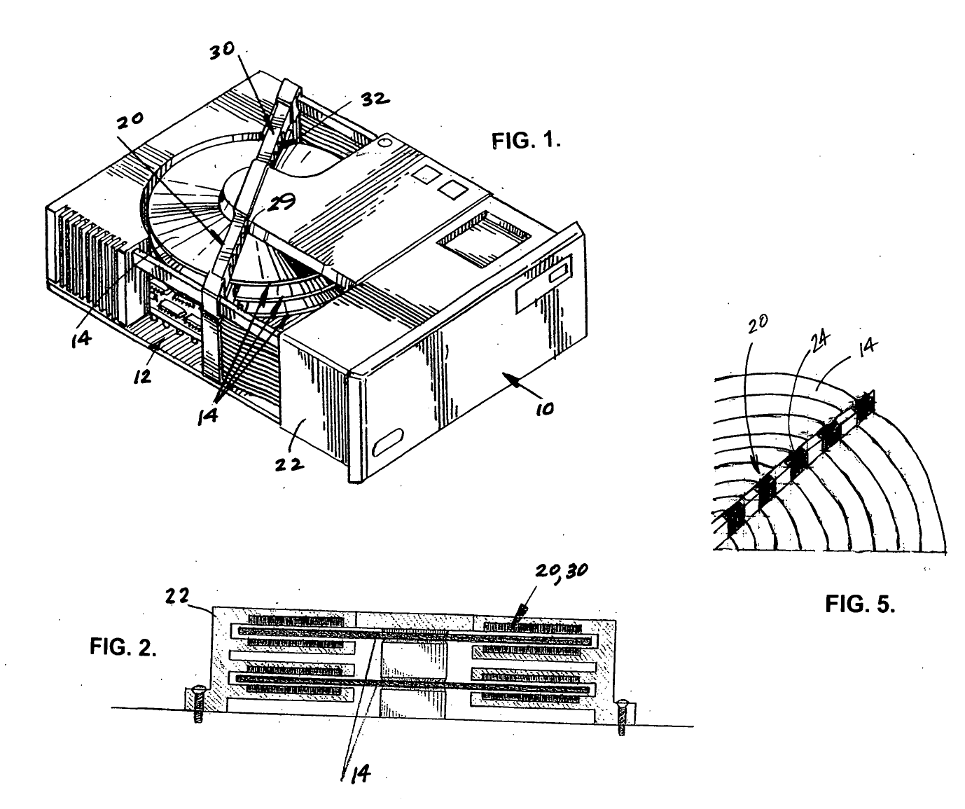

As can be understood from FIGS. 1 and 6, a plurality of discs can be stacked with each disc including a plurality of fixed read head units 20 and a plurality of fixed write head units 30 in the manner that will be understood from the teaching of the above disclosure.

The details of the circuits and the details of the hardware will be understood by those skilled in the art based on the teaching of the present disclosure and the exact details do not form a part of the present invention, and thus such details will not be further presented.

It is to be understood that while certain forms of the present invention have been illustrated and described herein, it is not to be limited to the specific forms or arrangements of parts as described and shown.

What is claimed and desired to be covered by Letters Patent is:

1. A read/write system for a hard drive comprising:
(a) a hard drive disc which is rotated during use;
(b) a read head unit which is fixed in place with respect to said hard drive disc whereby said hard drive disc rotates with respect to said read head unit, said read head unit including a plurality of data reading elements located to read data from said hard drive disc when necessary; and
(c) a write head unit which is fixed in place with respect to said hard drive disc whereby said hard drive disc rotates with respect to said write head unit, said write head unit including a plurality of data writing elements located to write data onto said hard drive disc when necessary.

2. The read/write system as described in claim 1 further including a plurality of read head units and a plurality of write head units.

3. The read/write system as described in claim 2 further including a plurality of hard drive discs.

4. The read/write system as described in claim 3 wherein each of said read head units and each of said write head units is oriented radially with respect to the hard disc.
